(19) United States
(12) Patent Application Publication
(10) Pub. No.: US 2019/0359137 A1
(43) Pub. Date: Nov. 28, 2019

(54) VEHICLE VISUAL RECOGNITION DEVICE

(71) Applicant: KABUSHIKI KAISHA TOKAI-RIKA-DENKI-SEISAKUSHO, Aichi (JP)

(72) Inventors: Shigeki YOSHIDA, Aichi (JP); Suguru FUJISAKI, Aichi (JP)

(21) Appl. No.: 16/477,676

(22) PCT Filed: Jan. 30, 2018
(86) PCT No.: PCT/JP2018/002986

§ 371 Date: Jul. 12, 2019

(30) Foreign Application Priority Data
Feb. 3, 2017 (JP) 2017-018704

(51) Int. Cl. B60R 1/074

(52) U.S. Cl. CPC B60R 1/074

(57) ABSTRACT

A vehicle visual recognition device includes a support body that supports a housing member so as to allow the housing member to swing, and a restricting member that is supported by the support body so as to be movable in an axial direction, and that is capable of restricting swinging of the housing member. The restricting member is urged in a swing direction of the housing member by an urging means.

### TECHNICAL FIELD

The present invention relates to a vehicle visual recognition device in which a visual recognition means assists visual recognition by an occupant of a vehicle.

### BACKGROUND ART

In an automobile door mirror device disclosed in Japanese Patent Application Laid-Open (JP-A) No. 2000-85470, a mirror holder is supported by a stand (main shaft) projecting out from a front door. A clutch is supported by the stand so as to be capable of moving along an axial direction, and a coil spring urges the clutch toward a main gear so as to restrict rotation of the main gear. Drive force from a motor acts on the main gear to swing a mirror about the main gear.

Note that in this automobile door mirror device, gaps required for assembly are present between grooves provided along an axial direction of the stand and protrusions provided to the clutch so as to engage with the grooves in the stand. The mirror holder therefore rattles in the swing direction.

### SUMMARY OF INVENTION

Technical Problem

In consideration of the above circumstances, an object of the present invention is to suppress swing direction rattling of a housing member in a vehicle visual recognition device.

### Solution to Problem

A vehicle visual recognition device of a first aspect includes a support body, a restricting member, and an urging means. The support body supports a housing member so as to allow the housing member to swing, the housing member housing a visual recognition means that assists visual recognition by an occupant of a vehicle. The restricting member is supported so as to be movable in an axial direction with respect to the support body, and is capable of restricting swinging of the housing member. The urging means urges the restricting member in a swing direction of the housing member.

A vehicle visual recognition device of a second aspect is the vehicle visual recognition device of the first aspect, wherein the urging means urges the restricting member in the axial direction so as to restrict swinging of the housing member.

A vehicle visual recognition device of a third aspect is the vehicle visual recognition device of the first aspect or the second aspect, wherein the urging means is a coil spring.

A vehicle visual recognition device of a fourth aspect is the vehicle visual recognition device of the third aspect, further including an abutting member, an anchor portion, and another anchor portion. The abutting member is provided at the support body and abuts one axial direction end side of the coil spring. The anchor portion anchors one length direction end side of the coil spring at the abutting member. The other anchor portion anchors another length direction end side of the coil spring at the restricting member.

### Advantageous Effects of Invention

In the vehicle visual recognition device of the first aspect, the visual recognition means assists visual recognition by the occupant of the vehicle, and the support body supports the housing member that houses the visual recognition means so as to allow the housing member to swing. The restricting member is supported by the support body so as to be capable of moving in the axial direction, and the restricting member is capable of restricting swinging of the housing member.

The urging means urges the restricting member in the swing direction of the housing member. This enables swing direction rattling of the housing member to be suppressed, even if gaps are present between the support body and the restricting member.

In the vehicle visual recognition device of the second aspect, the urging means urges the restricting member in the axial direction. Namely, the urging means provided in order to restrict swinging of the housing member is capable of suppressing swing direction rattling of the housing member.

In the vehicle visual recognition device of the third aspect, the urging means is a coil spring. Swing direction rattling of the housing member can accordingly be suppressed by elastic deformation of the coil spring in its radial direction.

In the vehicle visual recognition device of the fourth aspect, the abutting member that abuts the one axial direction end side of the coil spring is provided at the support body. The anchor portion that anchors the one length direction end side of the coil spring is provided at the abutting member, and the other anchor portion that anchors the other length direction end side of the coil spring is provided at the restricting member. Since the length direction end portions of the coil spring are anchored by the anchor portion and the other anchor portion at the same time, the coil spring undergoes elastic deformation in its radial direction. Namely, swing direction rattling of the housing member can be suppressed by the coil spring.

### BRIEF DESCRIPTION OF DRAWINGS

FIG. 1 is a face-on view illustrating a vehicle door mirror device according to an exemplary embodiment of the present invention, as viewed from the vehicle rear.

FIG. 2 is a face-on view illustrating a stowing mechanism in a vehicle door mirror device according to an exemplary embodiment of the present invention, as viewed from the vehicle rear.

FIG. 3 is a cross-section illustrating a stowing mechanism in a vehicle door mirror device according to an exemplary embodiment of the present invention, as viewed from the vehicle rear.

FIG. 4 is an enlarged perspective view of a support shaft of a stand of a stowing mechanism in a vehicle door mirror device according to an exemplary embodiment of the present invention.

FIG. 5 is a cross-section (taken along line 5-5 in FIG. 2) illustrating a stowing mechanism in a vehicle door mirror device according to an exemplary embodiment of the present invention, as viewed from above.

FIG. 6 is an exploded perspective view illustrating a coil spring and a clutch plate of a stowing mechanism in a vehicle door mirror device according to an exemplary embodiment of the present invention.

FIG. 7A is a perspective view of a cam plate of a stowing mechanism in a vehicle door mirror device according to an exemplary embodiment of the present invention.

FIG. 7B is a plan view of a cam plate of a stowing mechanism in a vehicle door mirror device according to an exemplary embodiment of the present invention.

FIG. 8A is a bottom face perspective view of a cam plate of a stowing mechanism in a vehicle door mirror device according to a modified example of an exemplary embodiment of the present invention.

FIG. 8A is a bottom face view of a cam plate of a stowing mechanism in a vehicle door mirror device according to a modified example of an exemplary embodiment of the present invention.

### DESCRIPTION OF EMBODIMENTS

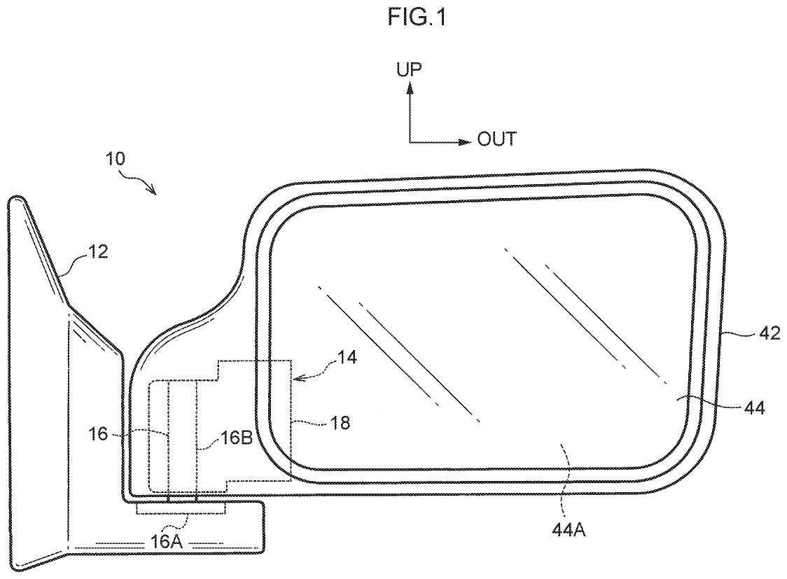

FIG. 1 is a face-on view illustrating a vehicle door mirror device 10 serving as a vehicle visual recognition device according to an exemplary embodiment of the present invention, as viewed from the vehicle rear. Note that in the drawings, the arrow FR indicates a vehicle front, the arrow OUT indicates a vehicle width direction outside (a vehicle right side), and the arrow UP indicates an upper side.

The vehicle door mirror device 10 according to the present exemplary embodiment is provided to a vertical direction intermediate portion of a vehicle front side end of a side door (in particular a front side door) serving as a vehicle door, and is disposed on the outside of the vehicle.

As illustrated in FIG. 1, the vehicle door mirror device 10 includes a stay 12, serving as an installation member. The vehicle door mirror device 10 is installed to the side door by fixing a vehicle width direction inside end of the stay 12 to the side door (the vehicle body side).

A stowing mechanism 14 (electric stowing mechanism, retractor), serving as a swing mechanism, is supported at the upper side of a vehicle width direction outside portion of the stay 12.

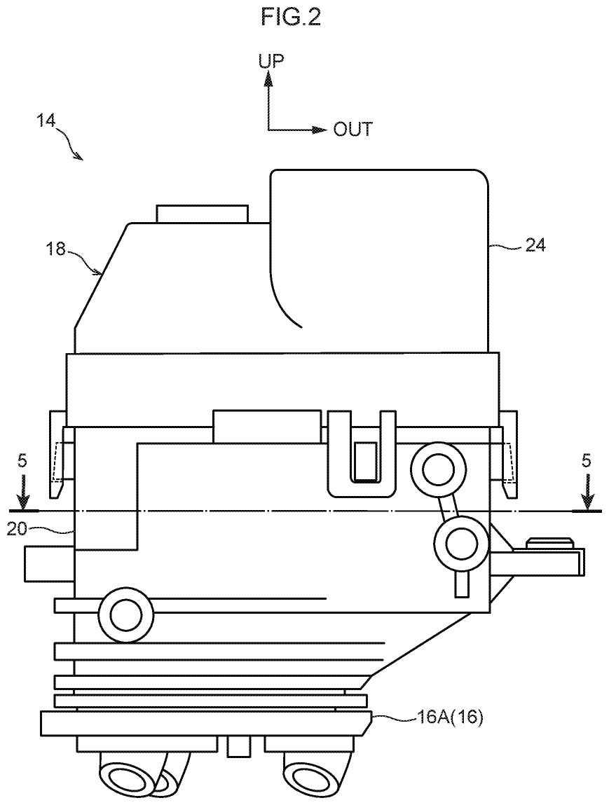

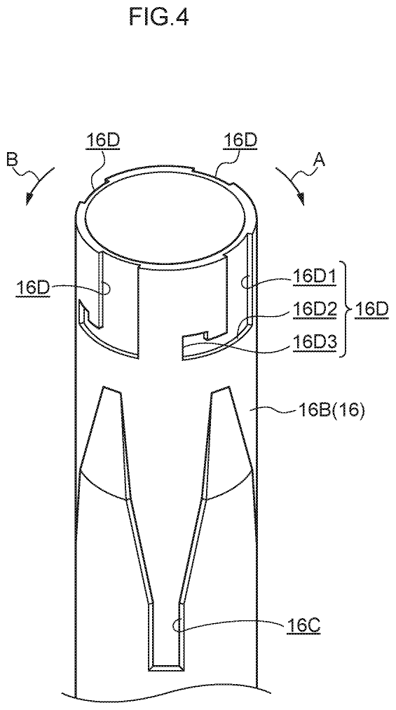

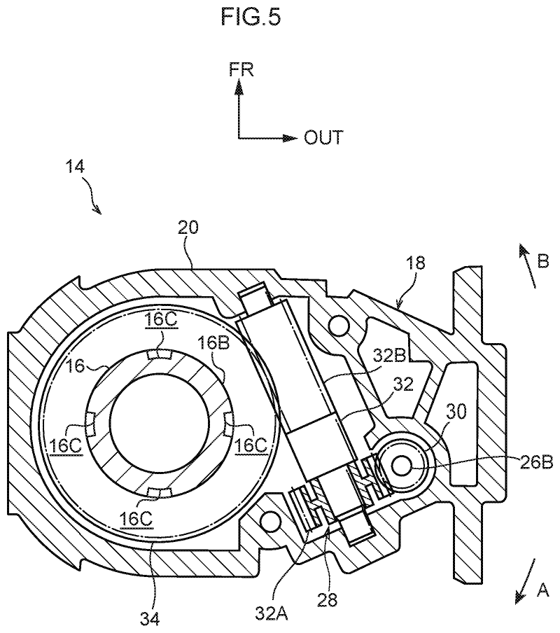

As illustrated in FIG. 2 to FIG. 5, a stand 16 made of metal and serving as a support body is provided to the stowing mechanism 14. A substantially disc shaped fixing portion 16A is provided to a lower end of the stand 16. The stand 16 is fixed to the stay 12 by fixing the fixing portion 16A to the stay 12, and the stowing mechanism 14 is supported by the stay 12. A substantially circular tube shaped support shaft 16B is integrally provided with the upper side of the fixing portion 16A, and the support shaft 16B is disposed with its axial direction running in the vertical direction. As illustrated in FIG. 4 and FIG. 5, a predetermined number of insertion grooves 16C (four in the present exemplary embodiment), each with a substantially rectangular shaped cross-section, are formed at an outer circumferential face of the support shaft 16B. The predetermined number of insertion grooves 16C are disposed at uniform spacings around the circumferential direction of the support shaft 16B. The insertion grooves 16C extend along the axial direction of the support shaft 16B and the insertion grooves 16C are open toward the upper side.

As illustrated in FIG. 4, a predetermined number of engaging grooves 16D (four in the present exemplary embodiment), each with a substantially J-shaped profile, are formed in the outer circumferential face of the support shaft 16B. The predetermined number of engaging grooves 16D are disposed at uniform spacings around the circumferential direction of the support shaft 16B. Each of the engaging grooves 16D includes an insertion portion 16D1 extending downward along the axial direction of the support shaft 16B, a slide portion 16D2 extending along a rearward folding direction (the arrow A direction in FIG. 4 and so on) from a lower end of the insertion portion 16D1, and a positioning portion 16D3 extending upward along the axial direction from a rearward folding direction end portion of the slide portion 16D2. Note that in each of the engaging grooves 16D, the widths of the insertion portion 16D1 and the positioning portion 16D3 in the support shaft 16B circumferential direction are both slightly wider than the width of engaging protrusions 40B, described later, and the width of the slide portion 16D2 in the support shaft 16B axial direction is slightly wider than the plate thickness of a cam plate 40, described later. The width of the positioning portion 16D3 in the support shaft 16B axial direction is slightly wider than the width of the slide portion 16D2 in the support shaft 16B axial direction.

A swing body 18 is supported by the support shaft 16B so as to be capable of swinging.

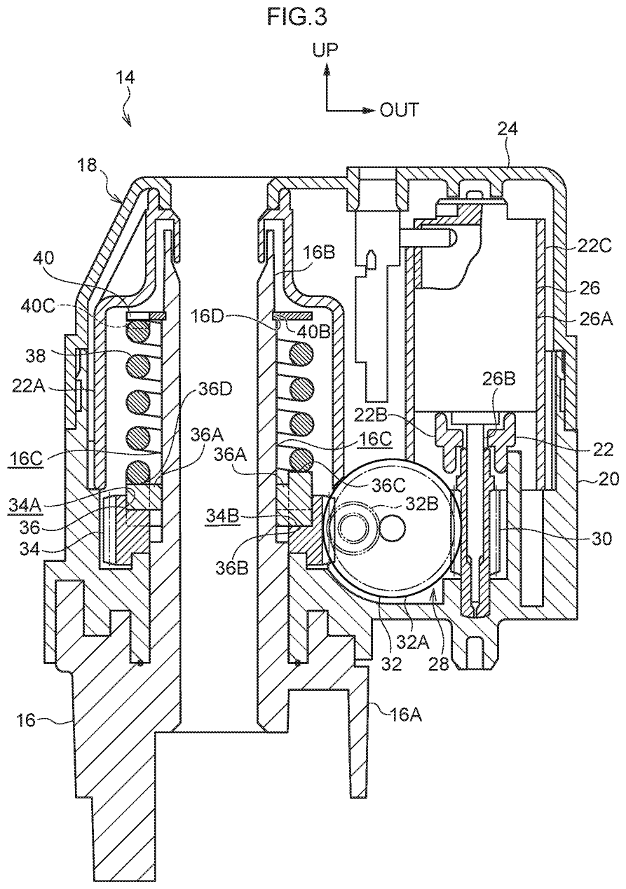

As illustrated in FIG. 2 and FIG. 3, a container-shaped case 20, made of resin and serving as a swinging member, is provided at a lower side portion of the swing body 18. An upper face of the case 20 is open. The support shaft 16B of the stand 16 penetrates and fits together with a vehicle width direction inside portion of a lower wall of the case 20. The case 20 is thus supported by the support shaft 16B so as to be capable of swinging.

As illustrated in FIG. 3, a motor base 22, made of resin and serving as an assembly member, is fixed inside an upper portion of the case 20. A substantially circular tube shaped housing tube 22A is provided at a vehicle width direction inside portion of the motor base 22. The support shaft 16B of the stand 16 is coaxially housed inside the housing tube 22A. A substantially rectangular plate shaped bottom wall 22B is provided at a vehicle width direction outside portion of the motor base 22. The bottom wall 22B is integrally formed to a lower end portion of the housing tube 22A. A substantially elliptical tube shaped assembly tube 22C is integrally provided with an upper face of the bottom wall 22B. The assembly tube 22C projects out from the bottom wall 22B toward the upper side.

A container-shaped cover 24, made of resin and serving as a covering member, is provided at the upper side of the case 20 and the motor base 22. A lower face of the cover 24 is open. A lower end of the cover 24 is fixed to an outer periphery of an upper end portion of the case 20. The cover 24 covers the upper side of the case 20 and the motor base 22.

A motor 26 serving as a drive means is provided inside the swing body 18. The motor 26 is provided with a substantially elliptical column shaped body 26A. The body 26A is assembled into and fixed to the assembly tube 22C of the motor base 22 from the upper side. A metal output shaft 26B (motor shaft) extends coaxially from the body 26A. The axial direction of the output shaft 26B is disposed running in the vertical direction. The output shaft 26B penetrates the bottom wall 22B of the motor base 22 and extends toward the lower side of the motor base 22. The stowing mechanism 14 is operated by driving the motor 26 to rotate the output shaft 26B.

A gear mechanism 28 is provided inside the case 20.

As illustrated in FIG. 3 and FIG. 5, a worm gear 30, made of resin and serving as a first stage gear, is provided to the gear mechanism 28 at the lower side of the motor 26. The worm gear 30 is disposed with its axial direction running in the vertical direction, and a lower portion of the worm gear 30 is supported by the lower wall of the case 20 such that the worm gear 30 is capable of rotating. The output shaft 26B of the motor 26 is coaxially inserted into the worm gear 30 from the upper side, and the worm gear 30 rotates as a unit together with the output shaft 26B when the output shaft 26B is rotated.

A worm shaft 32 serving as an intermediate gear is provided to the gear mechanism 28 at the vehicle width direction inside of the worm gear 30. The worm shaft 32 is disposed with its axial direction running in a horizontal direction, and is supported by the lower wall of the case 20 so as to be capable of rotating. A helical gear portion 32A made of resin is coaxially provided to the worm shaft 32 at one end side portion (a vehicle rear side portion) of the worm shaft 32, and a worm gear portion 32B made of metal and serving as a worm is coaxially provided to the worm shaft 32 at another end side portion (a vehicle front side portion) of the worm shaft 32. The helical gear portion 32A meshes with the worm gear 30, and when the worm gear 30 is rotated, the helical gear portion 32A and the worm gear portion 32B rotate together as a unit, thereby rotating the worm shaft 32.

A gear plate 34 (worm wheel), made of metal and serving as a rotation member (final gear), is provided to the gear mechanism 28 at the vehicle width direction inside of the worm shaft 32. The support shaft 16B of the stand 16 coaxially penetrates the gear plate 34. The gear plate 34 is supported by the support shaft 16B so as to be rotatable, and is supported from the lower side by the lower wall of the case 20.

A recessed portion 34A having a circular shape in plan view is coaxially formed in an upper face of the gear plate 34. The recessed portion 34A is open toward the upper side. A predetermined number of detent indents 34B (five in the present exemplary embodiment), serving as engaged portions, are formed in a lower face of the recessed portion 34A. The predetermined number of detent indents 34B are disposed at uniform spacings around the circumferential direction of the gear plate 34. Each of the detent indents 34B has an inverted trapezoidal shape in cross-section. The two side faces of each of the detent indents 34B are respectively inclined along directions toward the upper side on progression toward the gear plate 34 circumferential direction outside of the detent indent 34B.

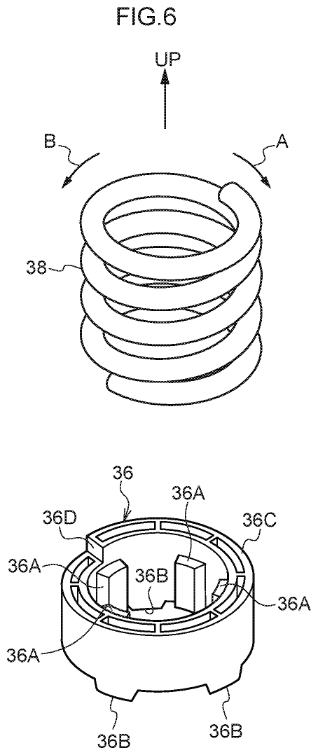

As illustrated in FIG. 3 and FIG. 6, a substantially circular tube shaped clutch plate 36, made of metal and serving as a restricting member, is provided at the upper side of the gear plate 34. The support shaft 16B of the stand 16 coaxially penetrates the clutch plate 36. The clutch plate 36 is fitted into the recessed portion 34A of the gear plate 34. A predetermined number of substantially rectangular column-shaped insertion protrusions 36A (four in the present exemplary embodiment) are formed at an inner peripheral surface of the clutch plate 36. The predetermined number of insertion protrusions 36A are disposed at uniform spacings around the circumferential direction of the clutch plate 36 and each extend along the axial direction of the clutch plate 36. The insertion protrusions 36A are inserted (substantially fitted together in the circumferential direction of the support shaft 16B and the clutch plate 36) into the insertion grooves 16C of the support shaft 16B. The clutch plate 36 is thereby anchored against rotating with respect to the support shaft 16B, but is capable of moving in the vertical direction with respect to the support shaft 16B.

A predetermined number of detent projections 36B (five, in the present exemplary embodiment), serving as engaging portions, are formed in a lower face of the clutch plate 36. The predetermined number of detent projections 36B are disposed at uniform spacings around the circumferential direction of the clutch plate 36. Each of the detent projections 36B has an inverted trapezoidal shape in cross-section. The two side faces of each of the detent projections 36B are respectively inclined along directions toward the lower side on progression toward the clutch plate 36 circumferential direction inside of the detent projection 36B. The cross-sectional shape of the detent projections 36B is configured in a similar shape to the cross-sectional shape of the detent indents 34B of the gear plate 34. The lower face of the clutch plate 36 makes contact with (is anchored to) the lower face of the recessed portion 34A of the gear plate 34 by inserting the detent projections 36B into the detent indents 34B (substantially fitting together in the circumferential direction of the gear plate 34 and the clutch plate 36).

A contact face 36C is formed at an upper face of the clutch plate 36. The contact face 36C is inclined in a downward direction on progression along the rearward folding direction. An urging face 36D with a planar face profile, serving as another anchor portion, is formed to the upper face of the clutch plate 36 between a rearward folding direction side end and a forward folding direction (see the arrow B direction in FIG. 6 and so on) side end of the contact face 36C. The urging face 36D is disposed so as to be perpendicular to the circumferential direction of the clutch plate 36.

A helical rod shaped metal coil spring 38 with a circular cross-section, serving as an urging means, is provided at the upper side of the clutch plate 36. The support shaft 16B of the stand 16 is coaxially inserted through the inside of the coil spring 38, and the coil spring 38 extends downward on progression along the rearward folding direction. An axial direction lower end of the coil spring 38 makes contact with the contact face 36C of the clutch plate 36. A length direction lower side end face of the coil spring 38 has a planar face shape, and makes contact with (is anchored to) the urging face 36D of the clutch plate 36. An axial direction upper end of the coil spring 38 contacts a lower face of the cam plate 40, described later. A length direction upper side end face of the coil spring 38 has a planar face shape, and makes contact with (is anchored to) the urging face 40C of the cam plate 40, described later.

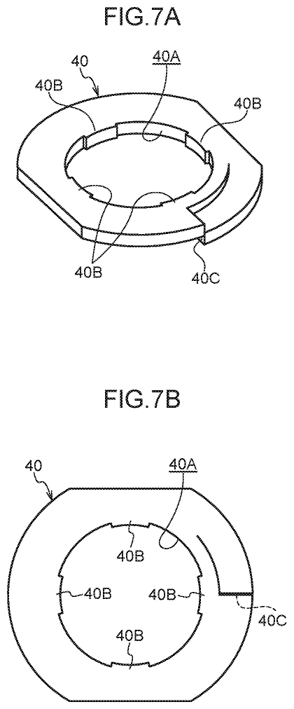

As illustrated in FIG. 3, the substantially annular plate-shaped cam plate 40 (see FIG. 7A and FIG. 7B), serving as an abutting member, is provided at the upper side of the coil spring 38. The cam plate 40 is coaxially fixed to the support shaft 16B of the stand 16. As illustrated in FIG. 7A and FIG. 7B, a circular insertion hole 40A is provided in the cam plate 40, and the support shaft 16B is inserted through the insertion hole 40A.

A predetermined number of the substantially rectangular shaped engaging protrusions 40B (four in the present exemplary embodiment) are formed at an inner peripheral surface of the insertion hole 40A. The predetermined number of engaging protrusions 40B are disposed at uniform spacings around the circumferential direction of the cam plate 40. The engaging protrusions 40B are inserted into (substantially fitted together with in the circumferential direction of the support shaft 16B and the cam plate 40) the positioning portions 16D3 (see FIG. 4) of the engaging grooves 16D of the support shaft 16B, such that the cam plate 40 is anchored against rotating with respect to the support shaft 16B, and upward movement with respect to the support shaft 16B is limited.

A slit is formed in the cam plate 40 so as to extend from an outer peripheral face of the cam plate 40 toward the insertion hole 40A and then extend in the forward folding direction around the insertion hole 40A. A rearward folding direction side of the cam plate 40 is bent downward along this slit (see FIG. 7A). The planar face shaped urging face 40C, serving as an anchor portion, is formed at a leading end of this bent portion, and the urging face 40C is disposed so as to be perpendicular to the circumferential direction of the cam plate 40.

As illustrated in FIG. 3, the cam plate 40 presses the coil spring 38 toward the lower side and compresses the coil spring 38 in its axial direction. The lower end of the coil spring 38 urges the contact face 36C of the clutch plate 36 toward the lower side, such that the coil spring 38 urges the clutch plate 36 toward the lower side. Urging force toward the lower side from the coil spring 38 causes the clutch plate 36 to engage with the gear plate 34, thereby maintaining a state in which the detent projections 36B of the clutch plate 36 have been inserted into the detent indents 34B of the gear plate 34. Namely, rotation of the gear plate 34 is restricted by the clutch plate 36.

The length direction upper side end face of the coil spring 38 is contacted and pressed toward the rearward folding direction side by the urging face 40C of the cam plate 40, causing the diameter of the coil spring 38 to elastically expand. The length direction lower side end face of the coil spring 38 urges the urging face 36D of the clutch plate 36 toward the rearward folding direction side, such that the coil spring 38 urges the clutch plate 36 toward the rearward folding direction side. The urging force toward the rearward folding direction side from the coil spring 38 thereby causes the rearward folding direction side faces of the insertion protrusions 36A of the clutch plate 36 to abut the rearward folding direction side faces of the insertion grooves 16C of the stand 16 (support shaft 16B).

The gear plate 34 is meshed together with the worm gear portion 32B of the worm shaft 32, such that the worm gear portion 32B is anchored against rotating about the gear plate 34, and the swing body 18 is anchored against swinging with respect to the gear plate 34. When the worm gear portion 32B is rotated, the worm gear portion 32B is rotated about the gear plate 34 such that the swing body 18 swings with respect to the gear plate 34 as a unit with the worm gear portion 32B.

As illustrated in FIG. 1, the swing body 18 is housed inside a vehicle width direction inside portion of a substantially cuboid container-shaped visor 42 serving as a housing member. A vehicle rear side face of the visor 42 is open. A substantially rectangular plate shaped mirror 44, serving as a visual recognition means, is housed inside the visor 42 in the vicinity of the vehicle rear side face (an open portion) of the visor 42. The visor 42 covers the entire periphery and a vehicle front side face of the mirror 44.

The visor 42 and the mirror 44 are coupled to and supported by the swing body 18. The visor 42 and the mirror 44, together with the swing body 18, project out with respect to the side door so as to flip out (open out) toward the vehicle width direction outside. A mirror face 44A of the mirror 44 faces toward the vehicle rear side. Accordingly, the mirror 44 enables a vehicle occupant (in particular the driver) to see behind the vehicle, and thereby assists visual recognition by the vehicle occupant. Furthermore, the visor 42 and the mirror 44 are capable of swinging about the support shaft 16B of the stand 16 as a unit with the swing body 18.

Explanation follows regarding an assembly operation of the coil spring 38 of the present exemplary embodiment.

First, a state is created in which the case 20 is supported by the support shaft 16B so as to be capable of swinging with respect to the support shaft 16B, and the gear plate 34 and the clutch plate 36 are inserted onto the support shaft 16B. In this state, an assembly technician inserts the coil spring 38 onto the support shaft 16B, and places the length direction lower side end face of the coil spring 38 in contact with the urging face 36D of the clutch plate 36 (see FIG. 3).

The assembly technician then inserts the cam plate 40 onto the support shaft 16B so as to insert the engaging protrusions 40B of the cam plate 40 into the insertion portions 16D1 of the engaging grooves 16D. When this is performed, the assembly technician adjusts the cam plate 40 in the circumferential direction such that the urging face 40C of the cam plate 40 is positioned at the forward folding direction side with respect to the length direction upper side end face of the coil spring 38, and then moves the cam plate 40 downward along the axial direction so as to be inserted onto the support shaft 16B. Note that by moving the cam plate 40 downward, the coil spring 38 is compressed in the axial direction between the cam plate 40 and the clutch plate 36. Namely, the assembly technician moves the cam plate 40 downward along the axial direction against the urging force of the coil spring 38.

When the engaging protrusions 40B abut the lower ends of the insertion portions 16D1, the assembly technician rotates the cam plate 40 in the rearward folding direction using a tool such as a spanner in a state in which the cam plate 40 is still being pressed downward. The cam plate 40 thereby rotates in the rearward folding direction as the engaging protrusions 40B are inserted into the slide portions 16D2 of the engaging grooves 16D. When the cam plate 40 rotates in the rearward folding direction, the urging face 40C of the cam plate 40 contacts the length direction upper side end face of the coil spring 38. Upon further rotation, the coil spring 38 undergoes elastic deformation in its radial direction. Namely, the assembly technician moves the cam plate 40 in the rearward folding direction around the circumferential direction against the circumferential direction urging force of the coil spring 38. Namely, the rearward folding direction corresponds to an urging direction in the circumferential direction of the coil spring 38.

When the engaging protrusions 40B abut rearward folding direction side end portions of the slide portions 16D2, the assembly technician releases the downward pressing force on the cam plate 40. When this occurs, the cam plate 40 is pressed back upward, while the engaging protrusions 40B are inserted into the positioning portions 16D3 of the engaging grooves 16D by the axial direction urging force of the coil spring 38. When the engaging protrusions 40B abut upper ends of the positioning portions 16D3, the cam plate 40 is anchored against rotating with respect to the support shaft 16B.

Although the assembly operation described above assumes a manual operation performed by an assembly technician, the assembly operation may be automated by employing a robot or the like.

Explanation follows regarding operation of the present exemplary embodiment.

In the stowing mechanism 14 of the vehicle door mirror device 10 configured as above, urging force toward the lower side from the coil spring 38 causes the clutch plate 36 to engage with the gear plate 34 (maintaining a state in which the detent projections 36B of the clutch plate 36 are inserted into the detent indents 34B of the gear plate 34), such that rotation of the gear plate 34 in the rearward folding direction (the direction of arrow A in FIG. 5, and so on) and the forward folding direction (the direction of arrow B in FIG. 5, and so on) with respect to the clutch plate 36 is restricted. Namely, the clutch plate 36 restricts swinging of the swing body 18, the visor 42, and the mirror 44 in the rearward folding direction (rear stowing direction) and the forward folding direction (front stowing direction).

When the stowing mechanism 14 is operated, the motor 26 is driven to rotate the output shaft 26B. Accordingly, in the gear mechanism 28, the worm gear 30 rotates as a unit together with the output shaft 26B, rotating the worm shaft 32 (the helical gear portion 32A and the worm gear portion 32B) to rotate the worm gear portion 32B about the gear plate 34, thereby swinging the swing body 18, the visor 42, and the mirror 44 together as a unit with the worm gear portion 32B with respect to the gear plate 34.

When the motor 26 is driven such that the output shaft 26B rotates in one direction, the worm gear portion 32B rotates in the rearward folding direction about the gear plate 34, and the swing body 18, the visor 42, and the mirror 44 swing in the rearward folding direction (toward the vehicle rear side and the vehicle width direction inside). Accordingly, the swing body 18, the visor 42, and the mirror 44 no longer project from the side door, and the swing body 18, the visor 42, and the mirror 44 are stowed (stowed to the rear).

Then, when the motor 26 is driven such that the output shaft 26B rotates in the other direction, the worm gear portion 32B rotates in the forward folding direction about the gear plate 34, and the swing body 18, the visor 42, and the mirror 44 swing in the forward folding direction (toward the vehicle front side and the vehicle width direction outside). The swing body 18, the visor 42, and the mirror 44 flip out (are returned) so as to project from the side door.

Furthermore, when external force from a large load in one out of the rearward folding direction or the forward folding direction acts on at least one of the visor 42 or the mirror 44, rotational force from the large load in the one out of the rearward folding direction or the forward folding direction is input to the gear plate 34 from the worm gear portion 32B of the swing body 18. This causes the clutch plate 36 to move toward the upper side with respect to the gear plate 34 against the urging force toward the lower side from the coil spring 38, and the clutch plate 36 disengages from the gear plate 34 (the detent projections 36B are no longer inserted into the detent indents 34B). Namely, rotation of the gear plate 34 in the one out of the rearward folding direction or the forward folding direction with respect to the clutch plate 36 is permitted since the lower face of the recessed portion 34A of the gear plate 34 is disposed at the lower side of the detent projections 36B, permitting the swing body 18, the visor 42, and the mirror 44 to be swung in the one out of the rearward folding direction or the forward folding direction.

Then, when external force in the rearward folding direction or the forward folding direction acts on at least one of the visor 42 or the mirror 44, or when the motor 26 is driven such that the worm gear portion 32B rotates, rotational force in the rearward folding direction or the forward folding direction is input to the gear plate 34 from the worm gear portion 32B. Accordingly, the gear plate 34 rotates in the rearward folding direction or the forward folding direction with respect to the clutch plate 36, and the urging force toward the lower side from the coil spring 38 causes the clutch plate 36 to move toward the lower side and engage the gear plate 34 (to insert the detent projections 36B into the detent indents 34B). Thus, rotation of the gear plate 34 in the rearward folding direction and the forward folding direction with respect to the clutch plate 36 is again restricted, restricting swinging of the swing body 18, the visor 42, and the mirror 44 in the rearward folding direction and the forward folding direction.

The coil spring 38 urges the clutch plate 36 toward a swing direction (rearward folding direction) side of the swing body 18, the visor 42, and the mirror 44, causing the rearward folding direction side faces of the insertion protrusions 36A of the clutch plate 36 to abut the rearward folding direction side faces of the insertion grooves 16C of the support shaft 16B. Thus, even when gaps required for assembly are present between the insertion protrusions 36A and the insertion grooves 16C in the clutch plate 36 circumferential direction, circumferential direction looseness of the clutch plate 36 with respect to the support shaft 16B can be suppressed. Moreover, the detent projections 36B that have inverted trapezoidal cross-sections are inserted into the detent indents 34B that have inverted trapezoidal cross-sections, such that the clutch plate 36 and the gear plate 34 are substantially fitted together. This enables circumferential direction looseness of the gear plate 34 with respect to the support shaft 16B to be suppressed, enabling looseness of the support shaft 16B with respect to the worm gear portion 32B that meshes with the gear plate 34 in the circumferential direction to be suppressed. Thus, in the present exemplary embodiment, rattling of the swing body 18, the visor 42, and the mirror 44 in the swing direction (the rearward folding direction (rearward stowing direction) and the forward folding direction (forward stowing direction)) is suppressed.

In the present exemplary embodiment, even when rotation force in the forward folding direction is input to the coil spring 38 when the motor 26 is driven, the coil spring 38 can be suppressed from undergoing elastic deformation (torsional deformation) toward the forward folding direction. Thus, even when the input of forward folding direction rotation force to the coil spring 38 ceases when driving of the motor 26 subsequently stops, the coil spring 38 can be suppressed from undergoing elastic recovery in the rearward folding direction. Metal-on-metal noises of the clutch plate 36 (insertion protrusions 36A) against the stand 16 (insertion grooves 16C), metal-on-metal noises of the clutch plate 36 (detent projections 36B) against the gear plate 34 (detent indents 34B), and metal-on-metal noises of the gear plate 34 (detent indents 34B) against the worm shaft 32 (worm gear portion 32B) due to the coil spring 38 undergoing elastic recovery toward the rearward folding direction can thereby be suppressed from occurring. Moreover, the coil spring 38 is suppressed from undergoing elastic deformation toward the forward folding direction when the motor 26 is driven, thereby obviating the need to apply lubricant (grease) between the coil spring 38 and the clutch plate 36 or between the coil spring 38 and the push nut 40, enabling costs to be reduced.

Moreover, the coil spring 38 of the present exemplary embodiment is employed to urge the clutch plate 36 in order to restrict swinging of the swing body 18, the visor 42, and the mirror 44. Namely, in the present exemplary embodiment, the coil spring 38 that is provided to urge the clutch plate 36 in the axial direction can be utilized to suppress rattling of the clutch plate 36 in the swing direction. This thereby enables the number of components to be reduced.

Furthermore, in the present exemplary embodiment, the length direction upper side end face of the coil spring 38 contacts the urging face 40C of the cam plate 40, and the length direction lower side end face of the coil spring 38 contacts the urging face 36D of the clutch plate 36. Namely, since the length direction end portions of the coil spring 38 are both anchored at the same time, the coil spring 38 undergoes elastic deformation in its radial direction. Thus, urging force toward the rearward folding direction side acts on the clutch plate 36 from the length direction lower side end face of the coil spring 38. Accordingly, in the present exemplary embodiment, the coil spring 38 is able to effectively apply urging force toward the rearward folding direction side to the clutch plate 36.

Furthermore, in the present exemplary embodiment, since the length direction end portions of the coil spring 38 are anchored to the cam plate 40 and the clutch plate 36 in the circumferential direction, there is no need to for processing to bend the length direction end portions of the coil spring 38, thereby enabling manufacturing costs to be reduced.

Note that although the two axial direction end faces of the coil spring 38 are not machined in the present exemplary embodiment, and the length direction end portions of the coil spring 38 therefore have circular cross-section profiles, there is no limitation thereto. For example, the two axial direction end faces of the coil spring 38 may be machined so as to provide the coil spring 38 with faces that are perpendicular to the axial direction. In such cases, the clutch plate 36 can still be urged in the swing direction as long as anchoring faces are formed at the length direction end portions of the coil spring 38.

Note that although the stowing mechanism 14 of the present exemplary embodiment is an electric stowing mechanism, there is no limitation thereto, and the stowing mechanism 14 may be a manual stowing mechanism.

Although the coil spring 38 urges the clutch plate 36 toward the rearward folding direction side in the present exemplary embodiment, the coil spring 38 may urge the clutch plate 36 toward the forward folding direction side.

Although the coil spring 38 urges the clutch plate 36 toward the rearward folding direction side in the present exemplary embodiment, an urging means other than the coil spring 38 may urge the clutch plate 36 toward the rearward folding direction side or the forward folding direction side.

Additionally, in the above exemplary embodiment, the vehicle visual recognition device of the present invention is the vehicle door mirror device 10. However, the vehicle visual recognition device of the present invention may be another vehicle mirror device (another vehicle outer mirror device outside the vehicle (for example, a vehicle fender mirror device) or a vehicle inner mirror device inside the vehicle), a vehicle camera device (that captures images to assist visual recognition by the vehicle occupant), or the like.

### MODIFIED EXAMPLE

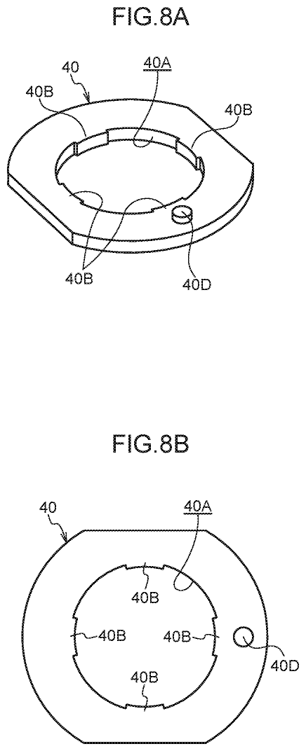

FIG. 8A and FIG. 8B illustrate a cam plate 40 of a modified example of the present exemplary embodiment.

As illustrated in FIG. 8A and FIG. 8B, the cam plate 40 of the modified example has a substantially annular plate shape, and is provided with a circular insertion hole 40A. The support shaft 16B is inserted through the insertion hole 40A. Similarly to in the present exemplary embodiment, a predetermined number of substantially rectangular shaped engaging protrusions 40B (four in the present exemplary embodiment) are formed at an inner peripheral surface of the insertion hole 40A, and the predetermined number of engaging protrusions 40B are disposed at uniform spacings around the circumferential direction of the cam plate 40.

A substantially circular column shaped protruding portion 40D, serving as an anchor portion, is formed to a lower face (the face on the upper side in FIG. 8A) of the cam plate 40. The axial direction of the protruding portion 40D is disposed so as to be perpendicular to the circumferential direction of the cam plate 40. In this modified example, the protruding portion 40D contacts the length direction upper side end face of the coil spring 38, such that the coil spring 38 urges the clutch plate 36 toward the rearward folding direction side.

The cam plate 40 of the above modified example enables similar operation and advantageous effects to those of the present exemplary embodiment to be obtained.

The entire content of the disclosure of Japanese Patent Application No. 2017-018704 filed on Feb. 3, 2017 is incorporated by reference in the present specification.

### EXPLANATION OF THE REFERENCE NUMERALS

10 vehicle door mirror device (vehicle visual recognition device)
16 stand (support body)
36 clutch plate (restricting member)
36D urging face (another anchor portion)
38 coil spring (urging means)
40 cam plate (abutting member)
40C urging face (anchor portion)
40D protruding portion (anchor portion)
42 visor (housing member)
44 mirror (visual recognition means)

1. A vehicle visual recognition device comprising:
a support body that supports a housing member so as to allow the housing member to swing, the housing member housing a visual recognition means that assists visual recognition by an occupant of a vehicle;
a restricting member that is supported so as to be movable in an axial direction with respect to the support body, and that is capable of restricting swinging of the housing member; and
an urging means that urges the restricting member in a swing direction of the housing member.

2. The vehicle visual recognition device of claim 1, wherein the urging means urges the restricting member in the axial direction so as to restrict swinging of the housing member.

3. The vehicle visual recognition device of claim 1 or claim 2, wherein the urging means is a coil spring.

4. The vehicle visual recognition device of claim 3, further comprising:
an abutting member that is provided at the support body and that abuts one axial direction end side of the coil spring;
an anchor portion that anchors one length direction end side of the coil spring at the abutting member; and
another anchor portion that anchors another length direction end side of the coil spring at the restricting member.

5. The vehicle visual recognition device of claim 4, wherein:
the abutting member includes:
an insertion hole penetrating in the axial direction, and
a plurality of protrusions provided at an inner peripheral surface of the insertion hole;
the support body includes:
a support shaft that axially supports the restricting member, and
a plurality of grooves that are provided at the support shaft, and that receive the protrusions when the support shaft is inserted through the insertion hole; and
each of the grooves includes:
an insertion portion that extends along the axial direction from an end portion of the support shaft,
a slide portion that extends from an end portion of the insertion portion in an urging direction about a circumferential direction of the coil spring, and
a positioning portion that extends along the axial direction from an urging direction end portion of the slide portion toward a location spaced apart from the end portion of the support shaft.

6. The vehicle visual recognition device of claim 4, wherein:
the abutting member is plate-shaped, and a portion of the abutting member is bent toward a coil spring side; and
the anchor portion is a leading end portion of the bent portion.

7. The vehicle visual recognition device of claim 4 or claim 5, wherein the anchor portion is a protrusion provided at a coil spring side of the abutting member.
